(19) United States
(12) Patent Application Publication
(10) Pub. No.: US 2013/0221072 A1
(43) Pub. Date: Aug. 29, 2013

(54) Ex Flux

(71) Applicant: Daniel Wessel, St. Louis, MO (US)

(72) Inventor: Daniel Wessel, St. Louis, MO (US)

(21) Appl. No.: 13/771,278

(22) Filed: Feb. 20, 2013

Related U.S. Application Data
(60) Provisional application No. 61/603,427, filed on Feb. 27, 2012.

(51) Int. Cl. B23K 3/08

(52) U.S. Cl. CPC B23K 3/082
USPC 228/35

(57) ABSTRACT

A flux application device is disclosed that allows users to solder copper pipe together with just one hand, thus the flux application device combines a brush and flux into one unit. The flux application device comprises a nozzle, a reservoir which typically comprises flux and is in fluid communication with the nozzle, and a brush head for applying the flux. The reservoir is a flexible reservoir containing flux that is secured to the nozzle to deliver the flux to a user. The flexible reservoir can be a reusable reservoir that a user would manually fill with flux, or a pre-filled replacement tube of flux.

### CROSS-REFERENCE

This application claims priority from Provisional Patent Application Ser. No. 61/603,427 filed Feb. 27, 2012.

### BACKGROUND

When performing basic plumbing tasks, it may be necessary to solder pipe and various connections together. Typically this task requires the use of multiple tools including, without limitation, a torch, fuel supply, solder, a brush and flux can. This task also requires a user to utilize both hands to hold the tools, which then makes it difficult to hold the items to be soldered as well. Thus, the process becomes inefficient and difficult to manage with only one person. Further, it may take much longer and become more expensive to fix a simple plumbing issue because an individual cannot fix the problem on their own. A device that allows an individual to solder pipe together with just one hand is necessary.

There is a need for a device that allows individuals to solder pipe and various other connections together with just one hand. The present invention makes it more convenient and efficient to apply flux to the items being soldered without the hassle of needing two hands to perform the task. The flux application device combines the flux and brush into one innovative unit, thereby speeding up the process of soldering items together. This device would be beneficial to professional plumbers as well as do-it-yourself household repairmen and women. This device makes it easy to perform basic plumbing tasks individually, which speeds up the process, reduces expenses, and allows an individual to work more efficiently. Anyone would benefit from using this versatile and convenient product.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a flux application device that allows users to solder two items together with just one hand, thus the flux application device combines a brush and flux into a single unit. The flux application device comprises a nozzle, a reservoir which typically comprises flux and is in fluid communication with the nozzle, and a brush head for applying the flux. The brush head is typically secured to a second end of the nozzle, and the reservoir is typically secured to a first end of the nozzle. The reservoir is a flexible reservoir containing flux that is secured to the nozzle to deliver the flux to a user. The flexible reservoir can be a reusable reservoir that a user would manually fill with flux, or any other suitable fluid.

In a preferred embodiment, the reservoir can be a pre-filled replacement tube of flux. Further, the pre-filled replacement tube of flux can comprise an air-tight seal (or tamper proof barrier), such as a foil seal, to prevent drying out of the flux. A user would then manually remove the tamper proof barrier (i.e., foil seal), and would attach the pre-filled replacement tube of flux onto the nozzle and would secure it. Additionally, the flux application device could comprise an internal pump assembly that pumps the flux or other suitable fluid from the reservoir and transfers it to the nozzle and onto the brush head. Typically, the reservoir would also comprise a manual dispensing component for activating the internal pump assembly.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the flux application device in accordance with the disclosed architecture.

FIG. 2 illustrates a perspective view of the flux application device with the brush head and the reservoir removed in accordance with the disclosed architecture.

FIG. 3A illustrates a perspective view of the flux application device with a replacement tube of flux in accordance with the disclosed architecture.

FIG. 3B illustrates a perspective view of the flux application device with the brush head and the replacement tube of flux removed in accordance with the disclosed architecture.

FIG. 4 illustrates a perspective view of the flux application device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a flux application device that allows users to solder two items, such as sections of copper pipe, together with a single hand. This device may resemble a caulk tube, and can include a flux brush on one end of the product to facilitate one handed application. This device may be constructed from a flexible material such as PVC or a similar material. It may also have removable replacement brush heads that are heat resistant. Exact dimensions or materials used may vary to suit manufacturing needs.

The disclosed flux application device combines a brush and flux into one unit. Specifically, the flux application device comprises a nozzle, a reservoir which typically comprises flux and is in fluid communication with the nozzle and the brush head, and a brush head for applying the flux. The reservoir is a flexible reservoir containing flux that is secured to the nozzle to deliver the flux to a user. The flexible reservoir can be a reusable reservoir that a user would manually fill with flux, or a pre-filled replacement tube of flux.

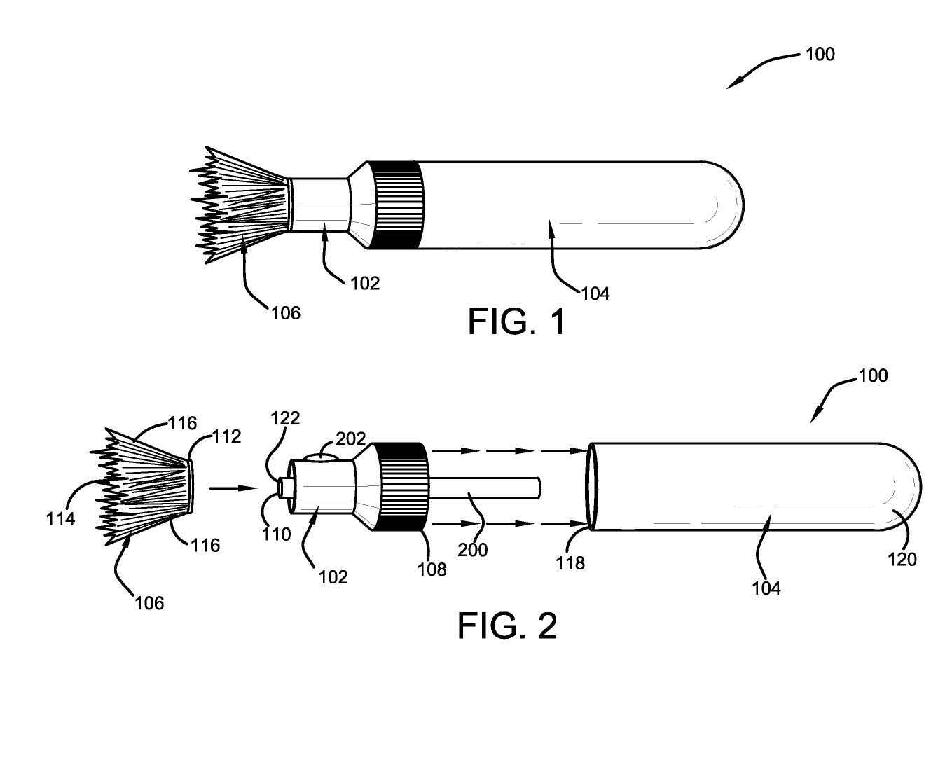

Referring initially to the drawings, FIGS. 1-2 illustrate the flux application device 100 that allows users to solder copper pipe together with just one hand, thus the flux application device 100 combines a brush and flux into one unit. The flux application device 100 comprises a brush head 106 for applying flux, a nozzle 102, and a reservoir 104 which typically comprises flux and is in fluid communication with the nozzle 102 and the brush head 106.

The nozzle 102 comprises a first end 108 and a second end 110. Typically, the nozzle 102 is cylindrical in shape, however any other suitable shape can be used as is known in the art without affecting the overall concept of the invention. The nozzle 102 would generally be constructed of polyvinyl chloride (PVC), acrylonitrile butadiene styrene (ABS), or any other similar polymer, etc., though any other suitable material may be used to manufacture the nozzle 102 as is known in the art without affecting the overall concept of the invention. The nozzle 102 can also comprise a variety of colors and designs to suit user and manufacturing preference. The nozzle 102 is approximately between 1 and 2 inches long as measured from the first end 108 to the second end 110, and approximately between 2 and 4 inches in diameter.

Typically, the nozzle 102 is hollow, but it does not have to be and can function by being partly solid, as long as flux from the reservoir 104 can pass through the nozzle 102 from the first end 108 to the second end 110 and be released through an opening 122 in the nozzle 102. Specifically, the nozzle 102 comprises at least one opening which is in fluid communication with the reservoir 104. Thus, flux from the reservoir 104 is transferred through the nozzle 102 to be released through the at least one opening in the nozzle 102 and onto the brush head 106 for application on the items being soldered.

Additionally, in another embodiment, the interior of the nozzle 102 can house a tube and pump assembly (not shown) that extends down into the reservoir 104. The tube can be a standard pump tube and a standard pump assembly as is known in the art that functions to draw flux from the reservoir 104 to the nozzle 102, to then be released by the nozzle 102.

The flux application device 100 further comprises a brush head 106 for applying the flux. The brush head 106 is typically secured to the second end 110 of the nozzle 102 via any suitable securing means as is known in the art, such as welding, gluing, threading, etc., and is in fluid communication with the nozzle 102. The brush head 106 would comprise at least one opening (not shown) within the bristles, which is also in fluid communication with the nozzle 102. Thus, the flux from the reservoir 104 is transferred through the nozzle 102 and through the at least one opening in the bristles, allowing the flux to coat the bristles.

Typically, the brush head 106 comprises heat resistant bristles and is conical in shape, however any other suitable shape can be used as is known in the art without affecting the overall concept of the invention. Further, the entire brush head 106 (as well as the bristles) could be constructed of heat resistant materials such as PVC, polycarbonate, polyetherimide, or any other similar thermoplastic, etc., though any other suitable material may be used to manufacture the brush head 106 as is known in the art without affecting the overall concept of the invention.

The brush head 106 can also comprise a variety of colors, logos, and designs to suit user and manufacturing preference. The brush head 106 is approximately between 1 and 2 inches long as measured from the first end 112 to the second end 114, and approximately between 1 and 2.5 inches in diameter as measured from opposing sides 116. The brush head 106 can also be disposable, such that a user (not shown) would unscrew the used brush head 106 and replace it with a new, replacement brush head 106. Further, additional replacement brush heads 106 can come in different sizes and shapes depending on the job to be done and/or the wants or needs of a user.

The flux application device 100 further comprises a reservoir 104 secured to the first end 108 of the nozzle 102 and in fluid communication with the nozzle 102. The reservoir 104 comprises a first end 118 and a second end 120. The first end 118 of the reservoir 104 is secured to the first end 108 of the nozzle 102 via any suitable securing means as is known in the art, such as welding, gluing, threading, etc., and is in fluid communication with the nozzle 102. Typically, the reservoir 104 is cylindrical in shape, however any other suitable shape can be used as is known in the art without affecting the overall concept of the invention.

Further, the reservoir 104 would generally be constructed of the same materials as the nozzle 102, such as PVC, ABS, or any other similar polymer, etc., though any other suitable material may be used to manufacture the reservoir 104 as is known in the art without affecting the overall concept of the invention. The reservoir 104 can also comprise a variety of colors, logos, and designs to suit user and manufacturing preference. The reservoir 104 is approximately between 4 and 8 inches long as measured from the first end 118 to the second end 120, and approximately between 2 and 4 inches in diameter.

Typically, the reservoir 104 is hollow, but it does not have to be and can function by being partly solid, as long as the reservoir 104 is in fluid communication with the nozzle 102. The reservoir 104 is a flexible reservoir containing flux that is secured to the nozzle 102 to deliver the flux to a user. The user would compress the flexible reservoir 104 which would force the flux from the reservoir 104 to the nozzle 102, and then the flux is released by the nozzle 102. The flexible reservoir 104 can be a reusable reservoir that a user would manually fill with flux, or any other suitable fluid.

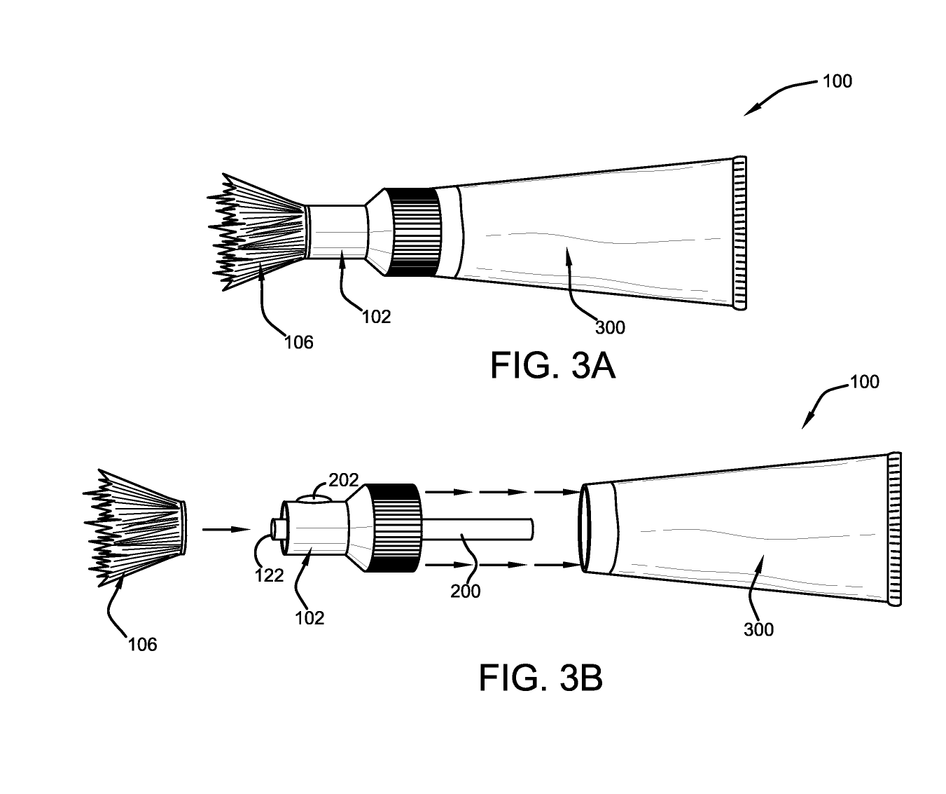

In contrast, the reservoir 104 can be a replacement tube 300 (as shown in FIGS. 3A and 3B) of flux. A user would take the pre-filled replacement tube 300 of flux and would remove the lid, usually by unscrewing it. Further, the pre-filled replacement tube 300 of flux can comprise an air-tight seal (or tamper proof barrier), such as a foil seal, to prevent drying out of the flux. A user would then manually remove the tamper proof barrier (i.e., foil seal), and would attach the pre-filled replacement tube 300 of flux onto the nozzle 102 and would secure it.

Additionally, the nozzle 102 could comprise a puncture component (not shown) secured to the first end 118 of the reservoir 104 which punctures the air-tight seal, when the pre-filled tube 300 of flux is screwed onto the nozzle 102. Typically, the replacement tube 300 of flux would be screwed onto the nozzle 102, but it can be secured to the nozzle 102 via any other suitable securement means as is known in the art without affecting the overall concept of the invention. Once secure, the flux application device 100 would be used as normal to apply flux. Once the replacement tube 300 of flux is empty, a user removes the empty tube and screws on a new, pre-filled replacement tube 300 of flux and the device is again ready for use.

The flux application device 100 may further comprise an internal pump assembly 200 that pumps the flux or other suitable fluid from the reservoir 104 and transfers it to the nozzle 102. The internal pump assembly 200 functions as a typical pump assembly to pull fluid from the reservoir 104 via a pump tube and transfer it to the nozzle 102 via the pump tube. Typically, the reservoir 104 would comprise a manual dispensing component 202 for activating the internal pump assembly 200. The manual dispensing component 202 would comprise a button, a trigger, or a pump, or any other suitable dispensing component as is known in the art without affecting the overall concept of the invention. The button would be simply pressed by a user as many times as needed. A user would press the manual dispensing component 202 which would activate the internal pump assembly 200 which would then draw fluid from the reservoir 104 and transfer it to the nozzle 102.

FIGS. 3A and 3B illustrate the flux application device 100 with a pre-filled replacement tube 300 of flux. As stated supra, the flux application device 100 comprises a reservoir which is secured to the nozzle 102 via any suitable securing means as is known in the art, such as welding, gluing, threading, etc. The reservoir is in fluid communication with the nozzle 102, and contains flux or any other suitable fluid. The reservoir 104 can be a reusable reservoir that a user would re-fill with flux, or any other suitable fluid (as shown in FIGS. 1 and 2). In contrast, the reservoir 104 can be a pre-filled replacement tube 300 of flux (as shown in FIGS. 3A and 3B).

A user would take the pre-filled replacement tube 300 and remove the lid, usually by unscrewing it. Further, the pre-filled replacement tube 300 of flux can comprise an air-tight seal (or tamper proof barrier), such as a foil seal, to prevent drying out of the flux. A user would then manually remove the tamper proof barrier (i.e., foil seal), or would use the nozzle 102 to puncture the air-tight seal. The user would then attach the pre-filled replacement tube 300 of flux onto the nozzle 102 and would secure it.

Typically, the replacement tube 300 of flux would be screwed onto the nozzle 102, but it can be secured to the nozzle 102 via any other suitable securement means as is known in the art without affecting the overall concept of the invention. Once secure, the flux application device 100 would then be used as normal to apply flux. Once the replacement tube 300 of flux is empty, a user removes the empty tube and screws on a new, pre-filled replacement tube 300 of flux.

Additionally, the flux application device 100 can comprise an internal pump assembly 200 that pumps the flux or other suitable fluid from the pre-filled replacement tube 300 and transfers it to the nozzle 102. The internal pump assembly 200 functions as a typical pump assembly to pull fluid from the replacement tube 300 via a pump tube and transfer it to the nozzle 102 via the pump tube.

A user would take the pre-filled replacement tube 300 and remove the lid, usually by unscrewing it. Further, the pre-filled replacement tube 300 of flux can comprise an air-tight seal (or tamper proof barrier), such as a foil seal, to prevent drying out of the flux. A user would then manually remove the tamper proof barrier (i.e., foil seal), or would use the nozzle 102 to puncture the air-tight seal. The user would then attach the pre-filled replacement tube 300 of flux onto the nozzle 102 and would secure it, such that the internal pump assembly 200 is encased within the replacement tube 300, which allows flux from the replacement tube 300 to be transferred to the nozzle 102 and through the nozzle opening 122.

Typically, the flux application device 100 would also comprise a manual dispensing component 202 for activating the internal pump assembly 200. The manual dispensing component 202 would comprise a button, a trigger, or a pump, or any other suitable dispensing component as is known in the art without affecting the overall concept of the invention. The button would be simply pressed by a user as many times as needed. A user would press the manual dispensing component 202 which would activate the internal pump assembly 200 which would then draw flux from the replacement tube 300 and transfer it to the nozzle 102.

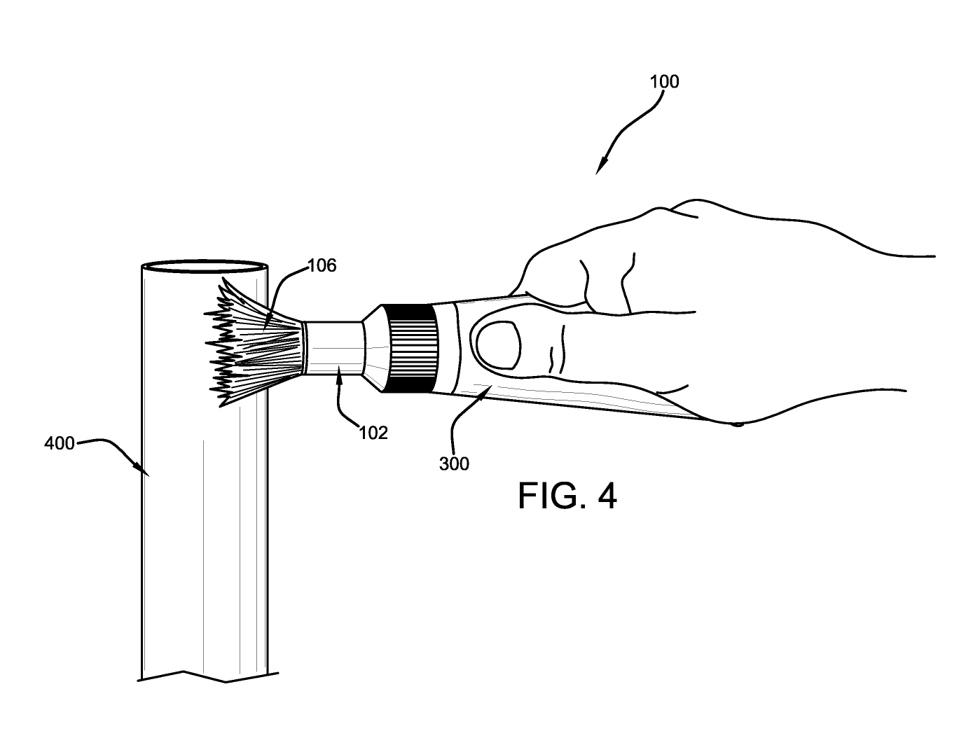

FIG. 4 illustrates the flux application device 100 in use. In operation, a user (not shown) would choose the color and/or specific design of the flux application device 100 that meets their needs and/or wants. The user would then either fill up the reservoir 104 with flux or would unscrew the cap of a pre-filled replacement tube 300 of flux and then would secure the filled reservoir 104 or replacement tube 300 to the nozzle 102. Typically, the user would screw on the reservoir 104 or replacement tube 300 directly onto the nozzle 102. Once the reservoir 104 or replacement tube 300 is secured to the nozzle 102, the user then inserts the brush head 106 over the nozzle 102 of the flux application device 100. The user secures the brush head 106 onto the nozzle 102 by screwing the brush head 106 onto the threads of the nozzle 102, such that the brush head 106 is securely retained on the nozzle 102.

Once the brush head 106 is secured to the nozzle 102, the user would compress the flexible reservoir 104 which would force the flux from the reservoir 104 to the nozzle 102, and then the flux is released by the nozzle 102 to the brush head 106. In contrast, if the flux application device 100 comprises an internal pump assembly 200, the user would press the manual dispensing component 202 which would activate the internal pump assembly which would then draw flux from the reservoir 104 and transfer it to the nozzle 102. Flux from the reservoir 104 is then dispensed from the nozzle 102 to the brush head 106. The brush head 106 retains the flux which is dispensed from the nozzle 102. The user continues to compress the flexible reservoir 104 or press the manual dispensing component 202 until the brush head 106 is saturated. Once the brush head 106 is saturated, the user proceeds with utilizing the saturated brush head 106 to apply flux to the copper pipe 400 as needed.

Furthermore, the brush head 106 can be removed and replaced. The brush head 106 can also be disposable, such that the user would unscrew the used brush head 106 and replace it with a new, replacement brush head 106. Further, additional replacement brush heads 106 can come in different sizes and shapes depending on the job to be done and/or the wants or needs of the user.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flux application device, comprising:
a nozzle comprising a first end and a second end;
a brush head secured to the second end of the nozzle; and
a reservoir secured to the first end of the nozzle and in fluid communication with the nozzle; and
wherein the reservoir comprises flux.

2. The flux application device of claim 1, wherein the brush head is a disposable brush.

3. The flux application device of claim 2, wherein the brush head comprises heat resistant bristles.

4. The flux application device of claim 1, wherein the reservoir is a pre-filled tube of flux, which can be screwed onto the first end of the nozzle.

5. The flux application device of claim 4, wherein the pre-filled tube of flux comprises an air-tight seal to prevent drying out of the flux.

6. The flux application device of claim 5, wherein the nozzle comprises a puncture component secured to the first end which punctures the air-tight seal, when the pre-filled tube of flux is screwed onto the nozzle.

7. The flux application device of claim 1, wherein the reservoir comprises an internal pump assembly for transferring the flux from the reservoir to the nozzle.

8. The flux application device of claim 7, wherein the reservoir comprises a manual dispensing component for activating the internal pump assembly.

9. A flux application device, comprising:
a nozzle comprising a first end and a second end;
a brush head secured to the second end of the nozzle; and
a pre-filled tube of flux secured to the first end of the nozzle and in fluid communication with the nozzle.

10. The flux application device of claim 9, wherein the pre-filled tube of flux is screwed onto the first end of the nozzle.

11. The flux application device of claim 10, wherein the pre-filled tube of flux comprises an air-tight seal to prevent drying out of the flux.

12. The flux application device of claim 11, wherein the nozzle comprises a puncture component secured to the first end which punctures the air-tight seal, when the pre-filled tube of flux is screwed onto the nozzle.

13. The flux application device of claim 9, wherein the brush head is a disposable brush.

14. The flux application device of claim 13, wherein the brush head comprises heat resistant bristles.

15. A flux application device, comprising:
a nozzle comprising a first end and a second end;
a brush head comprising heat resistant bristles which is secured to the second end of the nozzle; and
a pre-filled tube of flux secured to the first end of the nozzle and in fluid communication with the nozzle.

16. The flux application device of claim 15, wherein the brush head is a disposable brush.

17. The flux application device of claim 15, wherein the pre-filled tube of flux comprises an air-tight seal to prevent drying out of the flux.

18. The flux application device of claim 17, wherein the nozzle comprises a puncture component secured to the first end which punctures the air-tight seal, when the pre-filled tube of flux is screwed onto the nozzle.

19. The flux application device of claim 18, wherein the pre-filled tube of flux is screwed onto the first end of the nozzle.

20. The flux application device of claim 15, wherein the nozzle and pre-filled tube are manufactured of polyvinyl chloride.
